(19) United States
(12) Patent Application Publication
(10) Pub. No.: US 2008/0209917 A1
(43) Pub. Date: Sep. 4, 2008

(54) Storage Tank For Cryogenic Media

(75) Inventor: Robert Adler, Gerasdorf (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Munich (DE)

(21) Appl. No.: 11/917,755

(22) PCT Filed: Jun. 1, 2006
(86) PCT No.: PCT/EP2006/005244

§ 371 Date: Dec. 14, 2007

(30) Foreign Application Priority Data
Jun. 17, 2005 (DE) 10 2005 028 199.0

(51) Int. Cl. F17C 3/00; F17C 13/12; F17C 6/00

(52) U.S. Cl. 62/50.1; 220/560.04; 62/457.9; 220/560.11; 137/511

(57) ABSTRACT

A storage tank, in particular a storage tank for cryogenic media, preferably for liquid hydrogen, including at least one condensation pipe, which is used for delivering a gaseous cryogenic medium, is disclosed. In addition, a method for filling a storage tank with a gaseous cryogenic medium is disclosed. The condensation pipe is equipped with at least one heat exchanger via which the delivered cryogenic medium is cooled by exchanging heat with the stored cryogenic medium.

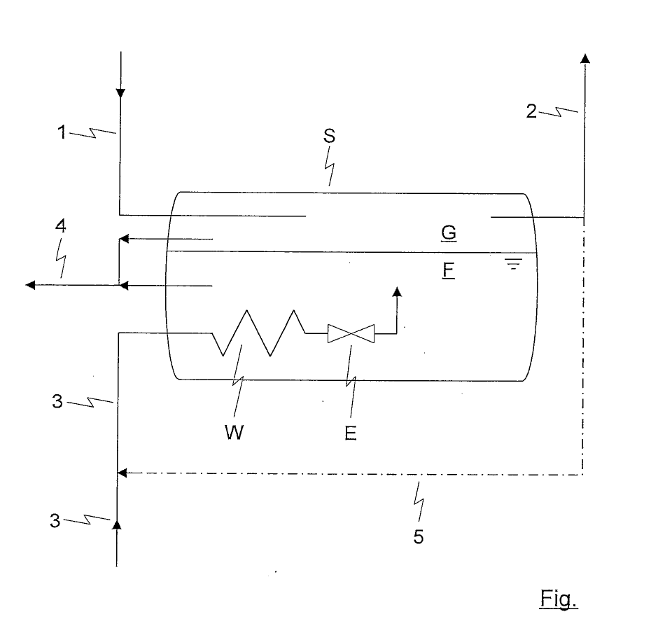

This application claims the priority of International Application No. PCT/EP2006/005244, filed Jun. 1, 2006, and German Patent Document No. 10 2005 028 199.0, filed Jun. 17, 2005, the disclosures of which are expressly incorporated by reference herein.

### BACKGROUND AND SUMMARY OF THE INVENTION

The invention relates to a storage tank, in particular for a storage tank for cryogenic media, preferably for liquid hydrogen, comprising of at least one condensation pipe, which is used for delivering a gaseous cryogenic medium.

In addition, the invention relates to a method for filling a storage tank as well as the use of a storage tank.

The term “cryogenic media” is understood in the following to refer to deep cold fluids, in particular liquid hydrogen, liquefied natural gas, liquid nitrogen, liquid oxygen and other liquefied gases.

Storage tanks, in particular storage tanks that are used to store cryogenic media, have, as a rule, an outer tank and an inner tank, as well as insulation arranged between the outer tank and the inner tank. As a rule, so-called super insulation is used to insulate storage tanks that are used to store cryogenic liquids and/or media. This insulation is comprised of several layers of thin aluminum foils and/or aluminum vacuum coated foils with woven glass fabric or a glass fleece layer in-between. The woven glass fabric and/or the glass fleece layer prevent the aluminum foils and/or the aluminum vacuum coated foils from touching, and triggering a thermal short circuit in the process.

Furthermore, generic storage tanks have filling and withdrawal pipes that are required for their respective intended use, via which the medium to be stored can be delivered to or removed from the storage tank.

In the following, the letters “G” for “gaseous” and “L” for “liquid” will precede the designations of special cryogenic media in accordance with their physical state of matter, i.e., GH₂ or LH₂, for gaseous or liquid hydrogen.

Hydrogen in particular is currently gaining significance as a source of energy due to increasing demand for energy and increased environmental consciousness. Thus, commercial vehicles, busses and passenger vehicles are already being propelled by means of hydrogen-powered engines or fuel cells. In addition, initial experiments are underway to power aircraft with the cited media.

It is most expedient to store hydrogen in liquid form “on board” the aforementioned means of transportation. Even though, for this purpose, the hydrogen must be cooled to approx. 21 K and kept at this temperature, something which can only be realized using appropriate insulating measures on the storage tanks or containers; storage in a gaseous state in the aforementioned means of transportation is less favorable because of the low density of GH₂, since this necessitates storage in large-volume and heavy storage tanks at high pressures.

If no medium is removed from these types of storage tanks over a long period of time, an increase in temperature and pressure occurs inside the inner tank due to the unavoidable incidence of heat from the environment on the inner tank in the medium being stored therein. In accordance with the pressure design of the inner tank, from time to time the gaseous medium must be emptied from or blown off the storage tank via a filling and/or withdrawal pipe in which a pressure relief valve is provided, for example. If the storage tank is provided in a motor vehicle, this quantity of gaseous medium is lost unused if an additional storage device, such as a metal hydride tank for example, is not provided for the quantity of medium being blown off.

Conventional storage tanks for liquid hydrogen allow holding times of two to three days before evaporation, and therefore loss of gaseous hydrogen occurs. The acceptance of hydrogen as a source of energy, particularly in the case of passenger vehicles, will also depend, among other things, upon the length of the holding time possible for passenger vehicles. The need to blow off hydrogen after two to three days will certainly be considered unacceptable by the customer.

In addition, there are application cases in which a cryogenic medium that originates from any source or that accumulates in any process is supposed to be returned to a storage tank. In this connection, until now, pressure relief of the gaseous cryogenic medium being returned (and thus re-condensation) has taken place outside the storage tank directly before delivery. However, this method only permits a comparatively low degree of condensation of the medium being returned to the storage tank to be achieved.

The objective of the present invention is disclosing a generic storage tank, as well as a generic method for the (re)condensation of a gaseous cryogenic medium in a storage tank filled with liquid in which the aforementioned disadvantages can be avoided.

In order to attain this objective, a storage tank is provided which is characterized in that the condensation pipe is equipped with at least one heat exchanger via which the delivered cryogenic medium is cooled by exchanging heat with the stored cryogenic medium.

A pressure-relieving device is arranged in the filling pipe in an advantageous manner in the flow direction behind the heat exchanger.

The method, in accordance with the invention for filling a storage tank with a gaseous cryogenic medium, is characterized in that the gaseous cryogenic medium is cooled with the liquid cryogenic medium stored in the storage tank, and then pressure is relieved.

According to the invention, the gaseous cryogenic medium to be returned is now cooled by exchanging heat with the stored cryogenic medium. First or directly after this cooling, the pressure relief of the medium being returned takes place. By using the inventive storage tank or the inventive method for filling a storage tank, it is therefore possible to achieve a substantially higher degree of condensation (as compared to the prior art) of the gaseous cryogenic medium delivered to the storage tank. As a result, returning the gaseous cryogenic medium becomes more independent of the respective prevailing internal pressure of the storage tank.

The result of realizing a higher degree of condensation is a considerable lengthening of the holding time of the inventive storage tank until the required blow off of the evaporated medium.

The stress to the storage tank is also reduced in the delivery or return of the gaseous cryogenic medium. The result of this is that, after switch-off, the storage tank assumes a more advantageous starting situation since it is less pre-stressed thermally than is the case with a conventional supply.

### BRIEF DESCRIPTION OF THE DRAWING

The inventive storage tank, the inventive method for filling a storage tank as well as other embodiments thereof are explained in greater detail in the following on the basis of the exemplary embodiment depicted in the FIGURE.

### DETAILED DESCRIPTION OF THE DRAWING

The FIGURE shows a lateral sectional representation through a possible embodiment of the inventive storage tank S. The tank is depicted only in a simplified manner, i.e., the inner tank and the outer tank are not shown separately. As a result, the depiction of the insulation that is arranged as a rule between the inner tank and the outer tank is also dispensed with.

A storage tank S as depicted in the FIGURE is suitable, for example, for the storage of liquid hydrogen F over whose surface a gas cushion G forms.

Hydrogen in liquid and/or gaseous form is supplied to the storage tank S via pipe 1.

Pipe 4 is used to remove liquid and/or gaseous hydrogen from the storage tank S.

Basically, the functions of the previously described pipes 1 and 4 (as well as pipes 2 and 3 that are still to be described) can also be realized in one single filling and removal pipe.

When the maximum permissible internal pressure of the storage tank is exceeded, any evaporated hydrogen that arises within the storage tank S is normally withdrawn from the gas chamber G of the storage tank S via an evaporation pipe 2, and then released to the atmosphere, for example.

According to the invention, any gaseous cryogenic hydrogen in the storage tank S to be recondensed or condensed is fed via the condensation pipe 3 into the liquid chamber F of the storage tank S, cooled down or supercooled in the heat exchanger W by the liquid hydrogen F, relieved in the pressure-relieving device E and then condensed or introduced into the liquid F. This process essentially runs independently of the prevailing internal pressure of the storage tank. As already explained, when the maximum permissible internal pressure of the storage tank is exceeded, the hydrogen is withdrawn from the gas chamber G of the storage tank S via the evaporation pipe 2.

The gaseous cryogenic hydrogen to be supplied to the storage tank S can either originate directly from the storage tank S itself (return then takes place via pipe 5—shown as a dashed and dotted line—that discharges into pipe 3), or from any other source or any other process from which it is fed to the storage tank S via pipe 3.

The pressure-relieving device E described above is preferably a restrictor.

The previously described condensing into the liquid F takes place in practice via one or more condensing pipes. In this case, we are dealing with one or more pipes leading into the liquid chamber F of the storage tank S, in which pipes are embodied in a partially perforated manner, at least in their end regions. This makes it possible to introduce the medium being condensed into the liquid F in a manner that is as uniform as possible.

The inventive storage tank is suitable as a stationary and/or mobile storage tank, in particular as a storage tank for motor vehicles.

1-4. (canceled)

5. A storage tank for cryogenic media, comprising a condensation pipe, which is used for delivering gaseous cryogenic medium, wherein the condensation pipe is equipped with a heat exchanger arranged in an internal space of the storage tank via which the delivered cryogenic medium is cooled by exchanging heat with cryogenic medium stored in the storage tank.

6. The storage tank according to claim 5, wherein the condensation pipe has a pressure-relieving device arranged in the internal space of the storage tank in a flow direction behind the heat exchanger.

7. A method for filling a storage tank with a gaseous cryogenic medium, wherein the gaseous cryogenic medium is cooled with liquid cryogenic medium stored in the storage tank and then pressure is relieved.

8. Use of a storage tank according to claim 5, as a stationary and/or a mobile storage tank.

9. The storage tank according to claim 5, wherein the storage tank is disposed within a motor vehicle.

10. An apparatus for storing a cryogenic media, comprising:
a storage tank;
a condensation pipe with a first end disposed within the storage tank and a second end disposed outside of the storage tank; and
a heat exchanger coupled to the first end of the condensation pipe within the storage tank.

11. The apparatus according to claim 10, wherein the heat exchanger is disposed within a liquid cryogenic media stored within the storage tank.

12. The apparatus according to claim 10, wherein the second end of the condensation pipe is coupled to an evaporation pipe of the storage tank.

13. The apparatus according to claim 11, further comprising a pressure-relieving device coupled to the first end of the condensation pipe within the storage tank and arranged behind the heat exchanger in a flow direction of the cryogenic media.

14. A method for filling a storage tank with a gaseous cryogenic medium, comprising the steps of:
providing the gaseous cryogenic medium to the storage tank by a condensation line; and
cooling the gaseous cryogenic medium by liquid cryogenic medium stored in the storage tank through a heat exchanger disposed within the liquid cryogenic media and coupled to the condensation line.

15. The method according to claim 14, further comprising the step of relieving a pressure of the cooled gaseous cryogenic medium in a pressure-relieving device disposed within the liquid cryogenic media and coupled to the heat exchanger.

16. The method according to claim 14, further comprising the step of supplying the gaseous cryogenic medium to the condensation line from an evaporation pipe of the storage tank.
